(19) United States
(12) Patent Application Publication
(10) Pub. No.: US 2014/0295293 A1
(43) Pub. Date: Oct. 2, 2014

(54) ELECTRODE AND MANUFACTURING METHOD THEREOF

(71) Applicant: HONDA MOTOR CO., LTD., TOKYO (JP)

(72) Inventors: Hidefumi NIKAWA, TOKYO (JP); Toshio TOKUNE, TOKYO (JP)

(73) Assignee: HONDA MOTOR CO., LTD., TOKYO (JP)

(21) Appl. No.: 14/222,840

(22) Filed: Mar. 24, 2014

(30) Foreign Application Priority Data
Mar. 27, 2013 (JP) 2013-067507

(51) Int. Cl. H01G 11/32; C01B 25/45; H01G 11/50; H01M 4/36

(52) U.S. Cl. CPC H01G 11/32; H01M 4/364; C01B 25/45; H01G 11/50
USPC 429/405; 429/218.1; 252/506; 361/502

(57) ABSTRACT

Provided is an electrode that contributes to higher performance improvement of batteries and capacitors by selecting a dispersant not only for uniformalizing an electrode structure but also playing the performance improvement role for the batteries or capacitors. An electrode 1 includes an active material 2 and a conductive additive 3. The electrode 1 also includes a dispersant 5, and the dispersant 5 is adsorbed onto the surfaces of the conductive additive 3 and the active material 2. More preferably, the electrode 1 includes the dispersant 5 having at least one kind selected from a group consisting of molecular structures, atoms, and ions which acts as a charge transfer medium, and most preferably, the electrode 1 includes the dispersant 5 having the same charge as the charge transfer medium contained in the active material 2.

This application is based on and claims the benefit of priority from Japanese Patent Application No. 2013-067507, filed on 27 Mar. 2013, the content of which is incorporated herein by reference.

### BACKGROUND OF THE INVENTION

1. Field of the Invention

The present invention relates to an electrode and a manufacturing method thereof. In detail, the invention relates to an electrode used in batteries or capacitors and a manufacturing method thereof.

2. Related Art

In general, an electrode used in batteries or capacitors is made up of, for example, an active material, a conductive additive, and a binder. In order that the batteries or capacitors exhibit sufficient performance, these components of the electrode are required to be uniformly dispersed in the electrode. When a uniform inner structure of the electrode is not formed, the reactivity of the active material is reduced, and the capacity and output of the batteries or capacitors are greatly reduced.

Therefore, in order to realize the uniform inner structure of the electrode, a method is widely known which includes processes of preparing a dispersion liquid by dispersing a dispersant added to the active material, the conductive additive, and the binder into a dispersion solvent and preparing an electrode from the dispersion liquid. For example, an electrode for a lithium-ion secondary battery is disclosed (for example, see Patent Document 1), in which an electrode is prepared using dispersants such as polyvinylpyrrolidone (PVP), polystyrene sulfonate (PSS), polyphenylacetylene (PAA), polymeta-phenylenevinylene (PmPV), polypyrrole (PPy), poly p-phenylene benzobisoxazole (PBO), natural polymers, anionic aliphatic surfactant, sodium dodecyl sulfate (SDS), cyclic polypeptide biosurfactant, surfactin, water-soluble polymers, carboxyl methyl cellulose (CMC), hydroxyl ethyl cellulose (HEC), polyvinyl alcohol (PVA), n-methyl pyrrolidone, polyoxyethylene surfactant, polyvinylidene fluoride (PVDF), polyacrylic acid, and polyvinyl chloride (PVC).

In addition, a method is disclosed in, (for example, see Patent Document 2), in which an electrode is manufactured in such a manner that a dispersion layer is formed using a dispersant with low molecular weight and then the dispersant is removed from the dispersion layer. As described above, conventionally, the dispersant is used only for the purpose of dispersing the active material, the conductive additive and the binder. Therefore, the dispersant is removed finally and is not contained in the electrode.
[Patent Document 1] U.S. Published Patent Application Publication, No. 2011/0171371, Specification
[Patent Document 2] Japanese Unexamined Patent Application, Publication No. 2011-82165

### SUMMARY OF THE INVENTION

However, in a process of removing dispersant, dispersibility is reduced with the removal of the dispersant and an active material, a conductive additive, and a binder are gradually aggregated. As a result, a uniform inner structure of the electrode is not obtained.

In addition, performance degradation and deterioration of the batteries or capacitors occur depending on the dispersant, for example, due to the molecular structures or compositions of the dispersant in many cases. In particular, charging/discharging characteristics are reduced by inhibiting the charge transfer medium (for example, lithium-ion, substantially, lithium-ion solvation, in the case of a lithium-ion secondary battery) entering into/passing out of the electrode depending on the dispersant, and the capacity is reduced by inhibiting dissolution of the charge transfer medium from the active material depending on the dispersant. However, with respect to the influence on the inner structure of the electrode due to the difference in the molecular structure or composition of the dispersant and the influence on the performance of the batteries or capacitors using the electrode, no research whatsoever has been carried to date.

The invention was made in view of the above problems and is to provide an electrode that contributes to higher performance improvement of batteries or capacitors by selecting the dispersant not only for uniformalizing the electrode structure but also playing a performance-improving role for the batteries or capacitors. Since the dispersant plays a performance-improving role for the batteries or capacitors, a more uniform electrode structure can be obtained without removing the dispersant in the manufacturing method of the electrode as in Patent Document 2.

In order to achieve the above objectives, the invention is to provide an electrode (for example, electrode 1 to be described below) including an active material (for example, active material 2 to be described below) and a conductive additive (for example, conductive additive 3 to be described below). The electrode also includes a dispersant (for example, dispersant 5 to be described below), and the dispersant is adsorbed onto the surface of the conductive additive and the active material.

Preferably, the dispersant includes a dispersant having at least one kind selected from a group consisting of molecular structures, atoms, and ions which acts as the charge transfer medium.

Preferably, the charge transfer medium has the same charge as the charge transfer medium contained in the active material.

Preferably, the charge transfer medium is the same as the charge transfer medium contained in the active material.

Preferably, the dispersant is an anionic surfactant.

Preferably, the dispersant is at least one kind selected from a group consisting of metal dodecyl sulfate, Metal dodecyl benzene sulfonate, and metal stearate.

Preferably, the dispersant is at least one kind selected from a group consisting of lithium dodecyl sulfate, sodium dodecyl sulfate, lithium dodecyl benzene sulfonate, sodium dodecyl benzene sulfonate, lithium stearate, and sodium stearate.

Preferably, the conductive additive is at least one kind selected from a group consisting of carbon nanotubes, carbon black, acetylene black, and Ketjen black.

Preferably, the carbon nanotubes include carbon nanotubes having metallic properties.

Preferably, the carbon nanotubes are multi-walled carbon nanotubes.

In addition, the invention is to provide a secondary battery, an air battery, and an electric double-layer capacitor which are each provided with the above-described electrode, respectively.

Preferably, the secondary battery is a lithium-ion secondary battery or a sodium-ion secondary battery. Preferably, the air battery is a lithium/air battery or a sodium/air battery. Preferably, the electric double-layer capacitor is a lithium-ion capacitor or a sodium-ion capacitor.

Furthermore, the invention relates to a manufacturing method for an electrode including a first process of preparing a dispersion liquid containing an active material (for example, active material 2 to be described below), a conductive additive (for example, conductive additive 3 to be described below), a solvent, and a dispersant using a dispersant (for example, dispersant 5 to be described below) having at least one kind selected from a group consisting of molecular structures, atoms, and ions which acts as a charge transfer medium; and a second process of manufacturing an electrode (for example, electrode 1 to be described below) by removing only the solvent from the dispersion liquid.

According to the invention, the dispersant used in preparing the electrode is selected to contribute to performance improvement of batteries or capacitors, and this dispersant is contained in the electrode without being removed. For this reason, dispersibility is reduced with the removal of the dispersant, and since aggregation of an active material or a conductive additive is avoided, a uniform inner structure of the electrode can be obtained. Accordingly, it is possible to provide the electrode capable of contributing to the performance improvement of the batteries or the capacitors.

In addition, according to the invention, since the dispersant contained in the electrode is adsorbed onto the surface of the conductive additive and the active material, this dispersant attracts an electrolyte toward the electrode. Thus, it is possible to improve the wettability of the interface between the electrode and the electrolyte and to increase the contact area between the electrode and the electrolyte.

Furthermore, since the dispersant is adsorbed onto the surface of the conductive additive and the active material, when the charge of the charge transfer medium contained in the dispersant is the same as the charge of the charge transfer medium contained in the active material, a layer having a charge opposite to the charge of the charge transfer medium is formed around the conductive additive. Then, the charge transfer medium is attracted to the layer having the opposite charge and thus is desorbed from the solvation state. Consequently, it is possible to substantially reduce solvation energy.

Furthermore, it is possible to form a conductive path for transporting the charge transfer medium by the layer having the charge opposite to that of the charge transfer medium formed around the conductive additive.

As a result, according to the embodiment, it is possible to improve charging capacity and output characteristics of the batteries or capacitors.

### BRIEF DESCRIPTION OF THE DRAWINGS

FIG. 1 is a diagram schematically illustrating the constitution of an electrode according to an embodiment of the invention.

FIG. 2 is a flowchart illustrating an example of the manufacturing method of the electrode according to the embodiment.

FIG. 3 is a diagram illustrating the electrochemical reaction model of the electrode according to the embodiment.

FIG. 4 is a diagram illustrating charging/discharging curves of batteries of Examples 1 to 3 and Comparative Example 1.

FIG. 5 is a diagram illustrating the charging/discharging curves of the batteries of Examples 1 and 5 to 7 and Comparative Example 2.

FIG. 6A illustrates an SEM image (magnification of 1,000 times) of the cross-section of the electrode of Example 1.

FIG. 6B illustrates an SEM image (magnification of 1,000 times) of the cross-section of the electrode of Example 2.

FIG. 6C illustrates an SEM image (magnification of 1,000 times) of the cross-section of the electrode of Example 3.

FIG. 6D illustrates an SEM image (magnification of 1,000 times) of the cross-section of the electrode of Comparative Example 1.

FIG. 6E illustrates an SEM image (magnification of 10,000 times) of the cross-section of the electrode of Example 1.

FIG. 6F illustrates an SEM image (magnification of 10,000 times) of the cross-section of the electrode of Example 2.

FIG. 6G illustrates an SEM image (magnification of 10,000 times) of the cross-section of the electrode of Example 3.

FIG. 6H illustrates an SEM image (magnification of 10,000 times) of the cross-section of the electrode of Comparative Example 1.

FIG. 6I illustrates an SEM image (magnification of 100,000 times) of the cross-section of the electrode of Example 1.

FIG. 6J illustrates an SEM image (magnification of 100,000 times) of the cross-section of the electrode of Example 2.

FIG. 6K illustrates an SEM image (magnification of 100,000 times) of the cross-section of the electrode of Example 3.

FIG. 6L illustrates an SEM image (magnification of 100,000 times) of the cross-section of the electrode of Comparative Example 1.

FIG. 7 is a diagram illustrating the charging/discharging curves of the batteries of Example 4 and Comparative Example 2.

FIG. 8 is a diagram illustrating the FT-IR spectrum of the electrodes of Example 4 and Comparative Example 2.

FIG. 9A illustrates an SEM image (magnification of 500 times) of the cross-section of the electrode of Example 1.

FIG. 9B illustrates an SEM image (magnification of 500 times) of the cross-section of the electrode of Example 8.

FIG. 9C illustrates an SEM image (magnification of 500 times) of the cross-section of the electrode of Example 9.

FIG. 9D illustrates an SEM image (magnification of 500 times) of the cross-section of the electrode of Example 10.

FIG. 10 is a diagram illustrating the charging/discharging curves of the batteries of Examples 1, 8 to 10 and Comparative Example 1.

### DETAILED DESCRIPTION OF THE INVENTION

An electrode according to an embodiment of the invention will be described in detail with reference to the drawings.

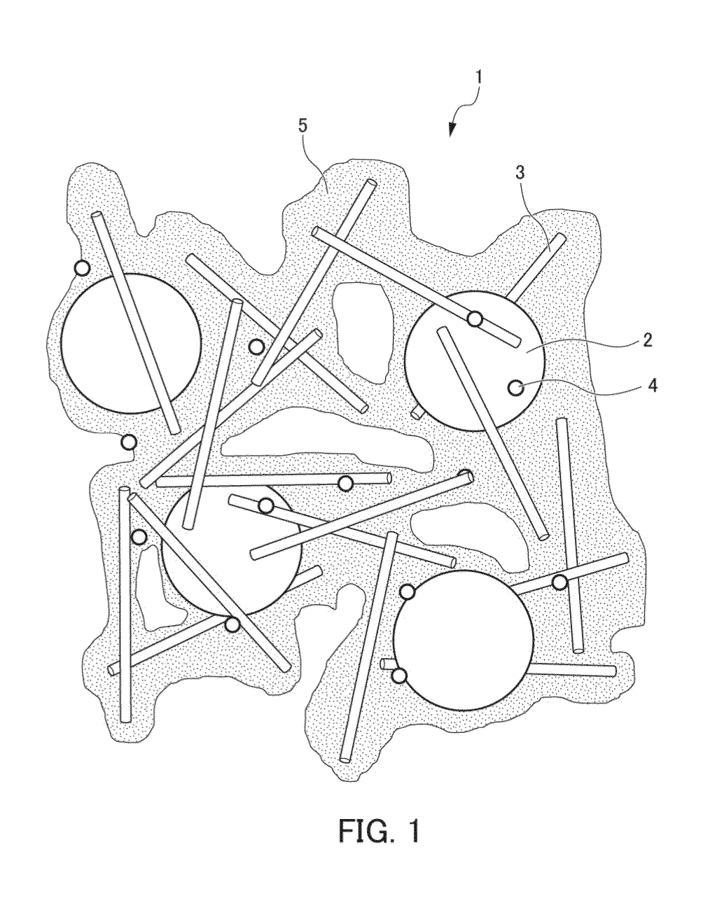

FIG. 1 is a diagram schematically illustrating the constitution of the electrode according to the embodiment. As illustrated in FIG. 1, an electrode 1 according to the embodiment is configured to include an active material 2, a conductive additive 3, a binder 4, and a dispersant 5.

The electrode 1 according to the embodiment is not limited to a lithium-ion secondary battery, but may be used in a sodium-ion secondary battery. In addition, the electrode may be used in a lithium/air battery or a sodium/air battery as a metal-air battery with energy density which is much higher than that of the secondary battery. Furthermore, it can be also used as an electrode of a capacitor and may be used in a lithium-ion capacitor or a sodium ion capacitor.

Here, the lithium-ion secondary battery and the lithium/air battery have a common active material and the same charge transfer medium, respectively, and the sodium-ion secondary battery and the sodium/air battery have a common active material and the same charge transfer medium, respectively. Therefore, the electrode 1 according to the embodiment can be easily applied to the metal-air battery such as the lithium/air battery or the sodium/air battery. This is also the case in an electric double-layer capacitor.

The electrode 1 according to the embodiment is used as any of the positive and negative electrodes in each battery or each capacitor described above. For example, it is possible to obtain each battery or each capacitor in which the electrode 1 according to the embodiment is used as the positive electrode and the negative electrode and this positive electrode and this negative electrode are separated by a separator. In addition, as will be described below, the electrode 1 according to the embodiment has excellent charging/discharging characteristics compared with the prior art.

The electrode 1 according to the embodiment includes the dispersant 5 and significantly differs from the conventional electrode in this regard. That is, the electrode 1 according to the embodiment is manufactured by a manufacturing method to be described below, but heat treatment is not performed as required in the prior art. Accordingly, the dispersant 5 remains without being removed, and a blended amount is contained intact in the electrode 1.

The dispersant 5 contained in the electrode 1 according to the embodiment is adsorbed on a surface of the conductive additive 3 and the active material 2. When being added into a solvent containing the active material 2 and the conductive additive 3 according to the manufacturing method to be described below, the dispersant 5 is adsorbed on the surface of the conductive additive 3 and the active material 2, and the adsorbed state is maintained even after filtration under reduced pressure.

Here, examples of “adsorption” in the embodiment include physical adsorption due to van der Waals force or π-π interaction, adsorption due to an ionic bond (anion-π interaction or cation-π interaction) or CH-π interaction, which is a type of a hydrogen bond, or chemical adsorption due to a covalent bond.

Preferably, the dispersant 5 includes a dispersant having at least one kind from a group consisting of molecular structures, atoms, and ions which acts as the charge transfer medium. The charge transfer medium preferably has the same charge as the charge transfer medium contained in the active material 2 and more preferably is the same as the charge transfer medium contained in the active material 2.

Here, the charge transfer medium contained in the active material 2 indicates Li⁺ ion (substantially, Li⁺ ion solvation) in, for example, the lithium-ion secondary battery, the lithium/air battery, and the lithium-ion capacitor. Moreover, the charge transfer medium contained in the active material 2 indicates Na⁺ ion (substantially, Na⁺ ion solvation) in, for example, the sodium-ion secondary battery, the sodium/air battery, and the sodium-ion capacitor.

Therefore, the dispersant preferably has the charge transfer medium of positive charge and more preferably has Li⁺ ion as the charge transfer medium in the lithium-ion secondary battery, the lithium/air battery, and the lithium-ion capacitor. Moreover, the dispersant has preferably the charge transfer medium of positive charge and more preferably has Na⁺ ion as the charge transfer medium in the sodium-ion secondary battery, the sodium/air battery, and the sodium-ion capacitor.

In the above-described dispersant 5, an anionic surfactant is preferably used and more preferably, at least one dispersant selected from a group consisting of metal dodecyl sulfate, metal dodecyl benzene sulfonate, and metal stearate is used.

Above all, at least one selected from a group consisting of lithium dodecyl sulfate (hereinafter, referred to as an “LDS”), which is the anionic surfactant having Li⁺ ion as the charge transfer medium, sodium dodecyl sulfate (hereinafter, referred to as an “SDS”), which is the anionic surfactant having Na⁺ ion as the charge transfer medium, lithium dodecyl benzene sulfonate (hereinafter, referred to as “LDBS”), sodium dodecyl benzene sulfonate (hereinafter, referred to as an “SDBS”), lithium stearate, and sodium stearate is more preferably used as the dispersant.

For example, when the LDS is used as the dispersant 5, the LDS is preferably contained to the extent of 0.01 mass % or more in an LDS-containing dispersant solution (hereinafter, referred to as an LDS dispersant solution), which is used in the manufacturing method of the electrode 1 to be described below. When the LDS content contained in the LDS dispersant solution is 1 mass % or more, excellent charging/discharging characteristics can be obtained compared with the prior art, resulting in improving battery output. More preferably, the LDS content contained in the LDS dispersant solution is 2.5 mass % or more. In addition, the upper limit of the LDS content in the LDS dispersant solution is the saturation content of the LDS contained in the LDS dispersant solution at the treatment temperature.

Here, the saturation content of the LDS in the LDS dispersant solution at the treatment temperature is experimentally required to be 30 mass %. In addition, the upper limit of the LDS content in the LDS dispersant solution at the treatment temperature is preferably 25 mass %. This is the limit value at which slurry can be experimentally prepared, and when the LDS is added in excess of this limit value, it turns into a jerry-like shape, which does not form a film. Furthermore, the upper limit of the LDS content in the LDS dispersant solution at the treatment temperature is more preferably 10 mass %. The LDS content in the binder of a general battery is about 5 mass %. Since the LDS plays the role of a binder and a conductive additive, it may be contained to the extent of up to 10 mass %.

However, for example, a nonionic surfactant not having the charge transfer medium can be used as the dispersant 5 in the embodiment. Specifically, for example, polyoxyyethlene octyphenyl ether (hereinafter, referred to as “Triton-X (registered trademark)”) may be used.

At least one selected from a group consisting of carbon nanotubes (hereinafter, referred to as “CNT”), carbon black, acetylene black, and Ketjen black is preferably used as the conductive additive 3.

Above all, CNT is more preferably used. CNT is a lightweight and high-strength material and has high conductivity, and thus it is suitable as the conductive additive 3. In addition, when the CNT is used, the amount of the conductive additive 3 to be blended with the active material 2 can be reduced compared to the general conductive additive of the prior art.

Examples of the CNT may include a multi-walled CNT (multi-walled carbon nanotube; hereinafter, referred to as “MWNT”), a few-walled CNT (few-walled carbon nanotube; hereinafter, referred to as “FWNT”), a double-walled CNT (double-walled carbon nanotube; hereinafter, referred to as “DWNT”), and a single-walled CNT (single-walled carbon nanotube; hereinafter, referred to as “SWNT”).

In these examples, the CNT having metallic properties is preferably used.

The active material 2 to be used is well known in the prior art. For example, lithium iron phosphate LiFePO₄ can be used in the lithium-ion secondary battery.

The binder 4 to be used is well known in the prior art. For example, PVDF (PolyVinylidene DiFluoride) can be used in the lithium-ion secondary battery. However, since the dispersant 5 contained in the electrode 1 has the same effect as the binder, the electrode 1 may be configured without using the binder. For this reason, the inner structure of the electrode is further simplified to easily obtain a uniform structure, and thus the mobility of the charge transfer medium is improved. Furthermore, when the binder is not used or is used in small quantities, the wettability (contact property) of electrolyte and the active material 2 of the electrode 1 is improved and concentration polarization is reduced.

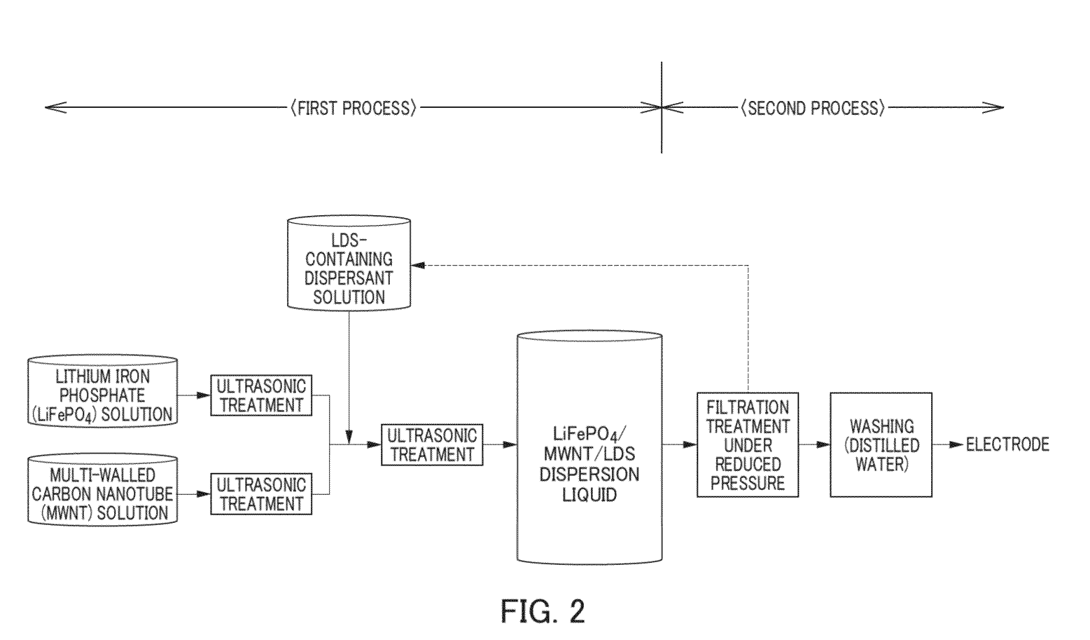

Next, a manufacturing method of the electrode 1 according to the embodiment will be described with reference to FIG. 2.

FIG. 2 is a flowchart illustrating an example of the manufacturing method of the electrode 1 according to the embodiment. FIG. 2 illustrates an example of the manufacturing method of the lithium-ion secondary battery. As illustrated in FIG. 2, the manufacturing method of the electrode 1 according to the embodiment includes a first process and a second process.

The first process is a process of preparing a dispersion liquid including the active material, the conductive additive, the solvent, and the dispersant. Specifically, first, a lithium phosphate LiFePO₄ solution is prepared as the active material by an ultrasonic treatment, and an MWNT solution is prepared as the conductive additive by a jet-mill treatment.

Subsequently, two prepared solutions are mixed with each other, and then the mixed solution is subjected to the ultrasonic treatment or the jet-mill treatment while the dispersant containing Li⁺ ion as the charge transfer medium, which is separately prepared, specifically, the solution containing the LDS is added. Thus, LiFePO₄/MWNT dispersion liquid is obtained as a desired dispersion liquid. Furthermore, in the dispersion liquid, the LDS as the dispersant is adsorbed onto the surfaces of the MWNT as the conductive additive and the lithium phosphate LiFePO₄ as the active material.

The second process is a process of manufacturing the electrode by removing only the solvent from the dispersion liquid prepared by the first process. Specifically, the LiFePO₄/MWNT dispersion liquid prepared by the first process is subjected to filtration treatment under reduced pressure to remove the only the solvent (for example, water) from the dispersion liquid. This significantly differs from the manufacturing method of the prior art in which the dispersant is actively removed by heating without actively leaving the dispersant.

The filtration under reduced pressure is performed by a vacuum filtering apparatus having a caliber of φ17 mm using membrane filter “A010A025A” (trade name) of φ25 mm in diameter and 0.1 μm in hole diameter, which is produced by ADVANTEC. Inc., in a ratio of 50 mL per one sheet. Furthermore, the dispersant adsorbed onto the surface of the MWNT of the conductive additive and the lithium phosphate LiFePO₄ of the active material is maintained at the adsorbed state without being removed by the filtration under reduced pressure.

Thereafter, it is possible to obtain the electrode 1 according to the embodiment by washing with the distilled water. In the electrode 1 obtained as described above, the dispersant 5 actively remains without being subjected to the heating treatment as in the prior art and the aggregation of the active material and the conductive additive can be avoided, resulting in having a uniform electrode structure.

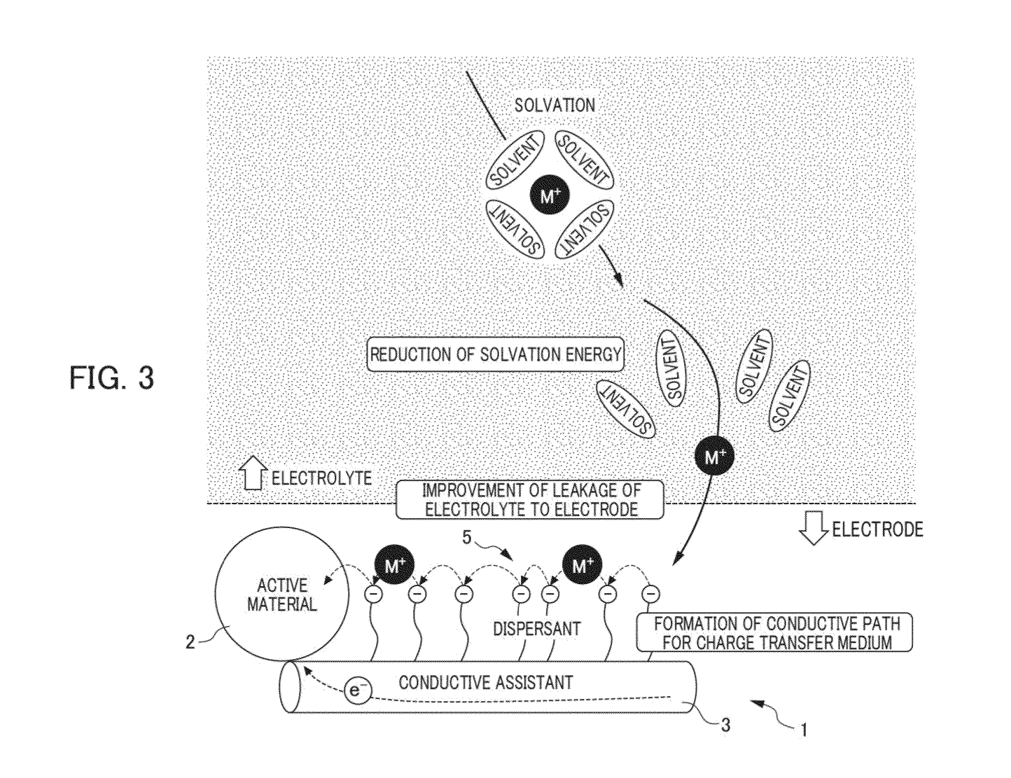

Operational effects of the electrode 1 according to the embodiment provided with the above constitution will be described with reference to FIG. 3.

FIG. 3 is a diagram illustrating an electrochemical reaction model of the electrode 1 according to the embodiment. In more detail, FIG. 3 illustrates the electrochemical reaction model at the interface between the negative electrode at the time of charging and the positive electrode at the time of discharging and the electrolyte, when the electrode 1 according to the embodiment is used.

First, according to the electrode 1 of the embodiment, the dispersant 5 is contained in the electrode 1 in a state being adsorbed onto the surface of the conductive additive 3 and the active material 2 without being removed, thereby obtaining the uniform inner structure of the electrode. Accordingly, the electrode 1 capable of contributing to performance improvement of the batteries or the capacitors can be provided.

However, as illustrated in FIG. 3, the electrochemical reaction in the electrode 1 is carried out by M⁺ ion (which indicates metal ions, for example, Li⁺ ion) as the charge transfer medium to be transported through the electrolyte, the active material 2 in the electrode 1, and electrons to be transported by an external circuit. For this reason, it is necessary that the electrode 1 has sufficient contact area (wettability) with the electrolyte.

In this regard, according to the electrode 1 of the embodiment, since the dispersant 5 contained in the electrode 1 is adsorbed onto the surface of the conductive additive 3 and the active material 2, the dispersant 5 attracts the electrolyte to the electrode 1 side. Thus, the wettability of the interface between the electrode 1 and the electrolyte can be improved, and the contact area between the electrode 1 and the electrolyte can be increased.

Furthermore, as illustrated in FIG. 3, the solvent in the electrolyte has polarity to attract the M⁺ ion (Li⁺ ion) as the charge transfer medium. Therefore, the electrolyte is in a solvation state at which the solvent surrounds the periphery of the M⁺ ion (Li⁺ ion) as the charge transfer medium. Here, in order to promote the electrochemical reaction in the electrode 1, it is necessary to take out the Li⁺ ion from the solvation state in the interface between the electrode 1 and the electrolyte.

At this time, it is important to reduce the required solvation energy. In this regard, according to the electrode 1 of the embodiment, since the dispersant 5 is adsorbed onto the surface of the conductive additive 3 and the active material 2, when the charge of the charge transfer medium contained in the dispersant 5 is the same as the charge of the charge transfer medium contained in the active material 2, a layer having a charge opposite to the charge of the charge transfer medium is formed around the conductive additive 3. Then, the charge transfer medium is attracted to the layer having the opposite charge and thus is desorbed from the solvation state. Consequently, it is possible to substantially reduce solvation energy.

Furthermore, according to the electrode 1 of the embodiment, it is possible to form a conductive path for transporting the charge transfer medium by the layer having the charge opposite to that of the charge transfer medium formed around the conductive additive 3.

As a result, according to the electrode 1 of the embodiment, it is possible to improve charging capacity and output characteristics of the batteries or capacitors.

Furthermore, the invention is not intended to be limited to the above embodiment, and various changes and modifications may be made within the scope capable of achieving the objects of the invention.

### EXAMPLES

Hereinafter, Examples of the invention will be described, but the invention is not limited to these Examples.

### Example 1

First, an amount of 90 mL of MWNT dispersion (0.3 mg/mL) was prepared by applying the ultrasonic treatment (output: 50 W) for one hour. Similarly, the amount of 90 mL of lithium iron phosphate LiFePO₄ dispersion (1.7 mg/mL) was prepared by applying the ultrasonic treatment (output: 50 W) for one hour.

Subsequently, after two prepared dispersions were mixed with each other, the amount of 120 mL of the dispersant solution, which was separately prepared, was added to the mixed dispersion. Then, LiFePO₄/MWNT dispersion liquid was obtained as a desired dispersion liquid by further applying the ultrasonic treatment (output: 50 W) for one hour.

In addition, a 1% LDS aqueous solution, which was the anionic surfactant having Li⁺ ion as the charge transfer medium, was used as the dispersant solution.

Subsequently, the obtained LiFePO₄/MWNT dispersion liquid was filtered under reduced pressure by 0.5 mL to remove water acting as the solvent. The filtration under reduced pressure was performed by a vacuum filtering apparatus having a caliber of φ17 mm using the membrane filter “A010A025A” (trade name) of φ25 mm in diameter and 0.1 μm in hole diameter, which was produced by ADVANTEC. Inc., in a ratio of 50 mL per one sheet. Thereafter, the filtered LiFePO₄/MWNT dispersion liquid was washed with 100 mL of distilled water and dried at 120° C. for 12 hours under the reduced pressure, resulting in obtaining the electrode.

### Example 2

Except for changing the kind of dispersant, the electrode was obtained in the same treatment ways as in Example 1. A 1% SDS aqueous solution, which was the anionic surfactant having Na⁺ ion as the charge transfer medium, was used as the dispersant.

### Example 3

Except for changing the kind of dispersant, the electrode was obtained via the same treatment ways as in Example 1. A 1% Triton-X (registered trademark) aqueous solution, which was the nonionic surfactant not having the charge transfer medium, was used as the dispersant.

### Example 4

First, a slurry was prepared by mixing the lithium iron phosphate LiFePO₄ as the active material, the acetylene black (hereinafter, referred to as “AB”) and Ketjen black (hereinafter, referred to as “KB”) as the conductive additive, and polyvinylidene fluoride (hereinafter, referred as “PVDF”) as the binder in a ball mill. Such a mixing ratio was set to satisfy the relation of LiFePO₄:AB:KB:PVDF=85:2:5:8, on a mass basis.

Subsequently, the prepared slurry was applied onto Al-collector foil and then was subjected to a drying treatment. Thereafter, it was impregnated with the 1% LDS aqueous solution for 12 minutes and then was washed with 100 mL of the distilled water. Then, it was dried at 120° C. for 12 hours under the reduced pressure, resulting in obtaining the electrode.

### Example 5

Except for changing the kind of conductive additive, the electrode was obtained via the same treatment ways as in Example 1. The SWNT was used as the conductive additive.

### Example 6

Except for changing the kind of conductive additive, the electrode was obtained via the same treatment ways as in Example 1. The FWNT (number of walls: about 2 to 5) was used as the conductive additive.

### Example 7

Except for changing the kind of conductive additive, the electrode was obtained via the same treatment ways as in Example 1. A SWNT having a length longer than the SWNT used in Example 5, specifically, a length about 1.1 to 10 times of its length was used as the conductive additive.

### Example 8

Except for changing the content of the LDS in the dispersant solution, the electrode was obtained via the same treatment ways as in Example 1. The content of the LDS in the dispersant solution was 2.5 mass %.

### Example 9

Except for changing the content of the LDS in the dispersant solution, the electrode was obtained in the same treatment ways as in Example 1. The content of the LDS in the dispersant solution was 5.0 mass %.

### Example 10

Except for changing the content of the LDS in the dispersant solution, the electrode was obtained via the same treatment ways as in Example 1. The content of the LDS in the dispersant solution was 7.5 mass %.

### Comparative Example 1

Compared with the treatment in Example 1, the LDS of the dispersant was not blended and isopropyl alcohol instead of water as the solvent was dispersed during dispersion. The dispersion liquid obtained by this was subjected to the above-described filtration treatment under reduced pressure, resulting in obtaining the electrode.

### Comparative Example 2

Compared with Example 4, the LDS was not subjected to the impregnation treatment, and the drying was performed at 120° C. for 12 hours under the reduced pressure, resulting in obtaining the electrode.

Evaluation

(Charging/Discharging Test of Electrodes of Examples 1 to 3 and Comparative Example 1)

Each electrode obtained in Examples 1 to 3 and Comparative Example 1 was subjected to a charging/discharging test after being incorporated in the lithium-ion battery. The charging/discharging test was evaluated using a formed composite film as a positive electrode and by using metal lithium as a counter electrode and a reference electrode, after powders in which a lithium iron olivinate and each CNT described above were mixed by a ratio of 85 mass %:15 mass %, respectively, were dispersed into the dispersant-added water. At that time, an ethylene carbonate (EC)/diethyl carbonate (DEC) (=3/7) solution obtained by dissolving 1 M LiPF₆ was used as an electrolyte, and a microporous film was used as a separator. In the charging/discharging test, a cutoff voltage was set to 2.5 to 4.0 V and a constant current charging/discharging test was performed at various kinds of current density at room temperature.

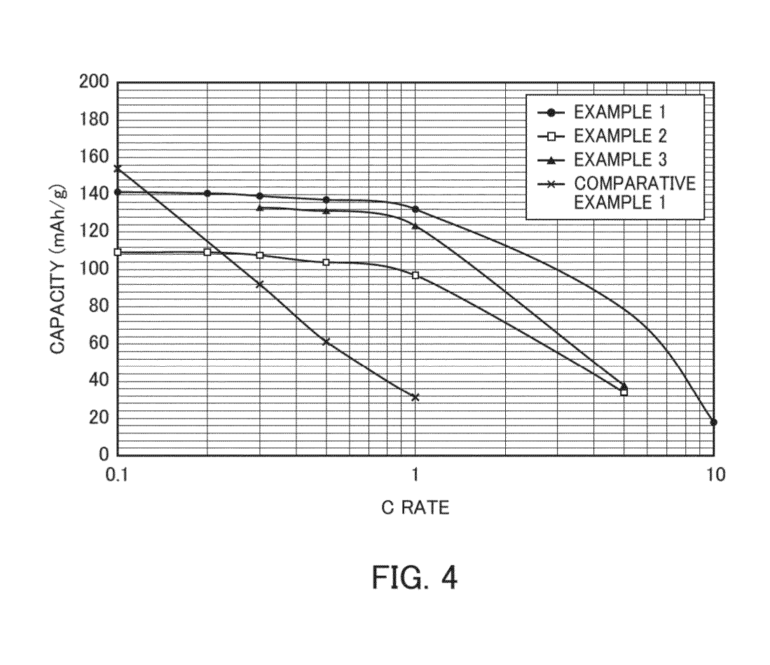

FIG. 4 is a diagram illustrating the charging/discharging curves of the batteries of Examples 1 to 3 and Comparative Example 1. In FIG. 4, the vertical axis indicates capacity (mAh/g) and the horizontal axis indicates C rate (the same hereinafter). Here, the C rate indicates current value (A)/capacity (Ah), and 1 C rate is the current magnitude at which the total capacity of the battery is discharged in one hour.

As illustrated in FIG. 4, the capacity was not significantly varied up to 1 C rate but gradually decreased from the 1 C rate in Examples 1 to 3. On the other hand, compared with these Examples, the capacity rapidly decreased as the C rate became higher even at the 1 C rate or lower, in Comparative Example 1. From this result, it was confirmed that Examples 1 to 3 using the electrode containing the dispersant had excellent output characteristics compared with Comparative Example 1 using the electrode not containing the dispersant.

Furthermore, it was confirmed that, among Examples 1 to 3, Example 1 using the electrode containing the LDS as the dispersant had the most excellent charging capacity and output characteristics and that the charging capacity and output characteristics were subsequently excellent in the order of Example 3 using the electrode containing the Triton-X (registered trademark) as the dispersant and Example 2 using the electrode containing the SDS as the dispersant, from the capacity value with respect to the C rate.

It was considered that the reason why the charging capacity and output characteristics were the most excellent in Example 1 was as follows. That is, the electrode of Example 1 contains the Li⁺ ion as the charge transfer medium contained the lithium iron phosphate LiFePO₄ as the active material and the dispersant LDS having the same Li⁺ ion as the charge transfer medium. For this reason, the following effects were exhibited in Example 1: (i) an effect to improve the wettability of the interface between the electrode and the electrolyte and to increase the contact area between the electrode and the electrolyte; (ii) an effect to reduce solvation energy by a layer having a charge opposite to that of the charge transfer medium formed around the conductive additive; and (iii) an effect to form a conductive path for transporting the charge transfer medium by the layer having the charge opposite to that of the charge transfer medium formed around the conductive additive. Thus, it was considered that the greatest charging capacity and output characteristics were obtained in Example 1.

In addition, the electrode of Example 2 contained the dispersant SDS having the charge transfer medium with the same charge as the Li⁺ ion as the charge transfer medium contained in the lithium iron phosphate LiFePO₄ as the active material and thus exhibited the above-described effects (i) to (iii) as in Example 1.

Thus, it was considered that the greatest charging capacity and output characteristics were also obtained in Example 2. However, in the electrode of Example 2, Na⁺ ion as the charge transfer medium derived from the dispersant not contained in the active material intruded into the active material, and deterioration of the active material occurred, for example, it was difficult to take out Li⁺ ions. Thus, it was considered that the electrode of Example 2 had a charging capacity and output characteristics inferior to those of the electrodes of Examples 1 and 3.

Furthermore, the electrode of Example 3 contained the Triton-X (registered trademark), which is the nonionic surfactant, as the dispersant and thus exhibited the above-described effect (i). Thus, it was considered that the electrode of Example 3 obtained the second greatest charging capacity and output characteristics, after those of the electrode of Example 1.

(Charging/Discharging Test of Electrodes of Examples 1 and 5 to 7 and Comparative Example 2)

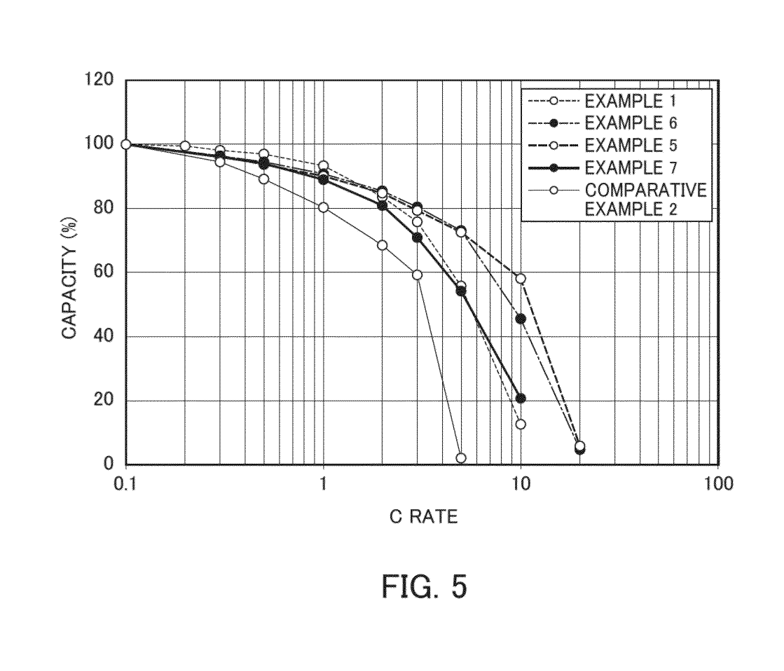

Each electrode obtained in Examples 1 and 5 to 7 and Comparative Example 2 was subjected to the charging/discharging test after being incorporated in the lithium-ion battery. The charging/discharging test was performed under the same conditions as in the above-described charging/discharging test. FIG. 5 is a diagram illustrating the charging/discharging curves of the batteries of Examples 1 and 5 to 7 and Comparative Example 2. The horizontal axis is the same as in FIG. 4, and the vertical axis indicates the ratio % to capacity (mAh/g) at the time of 0.1 C rates.

As illustrated in FIG. 5, it was found that all of Examples 5 and 7 in which the conductive additive MWNT of Example 1 was changed into SWNT and Example 6 in which the conductive additive MWNT was changed into FWNT had the excellent output characteristics as in Example 1, compared with Comparative Example 2. From this result, in the invention, it was confirmed that even when any of the MWNT, SWNT, and FWNT was used as the conductive additive, excellent output characteristics could be obtained.

(Cross-Section Observation with SEM of Electrodes of Examples 1 to 3 and Comparative Example 1)

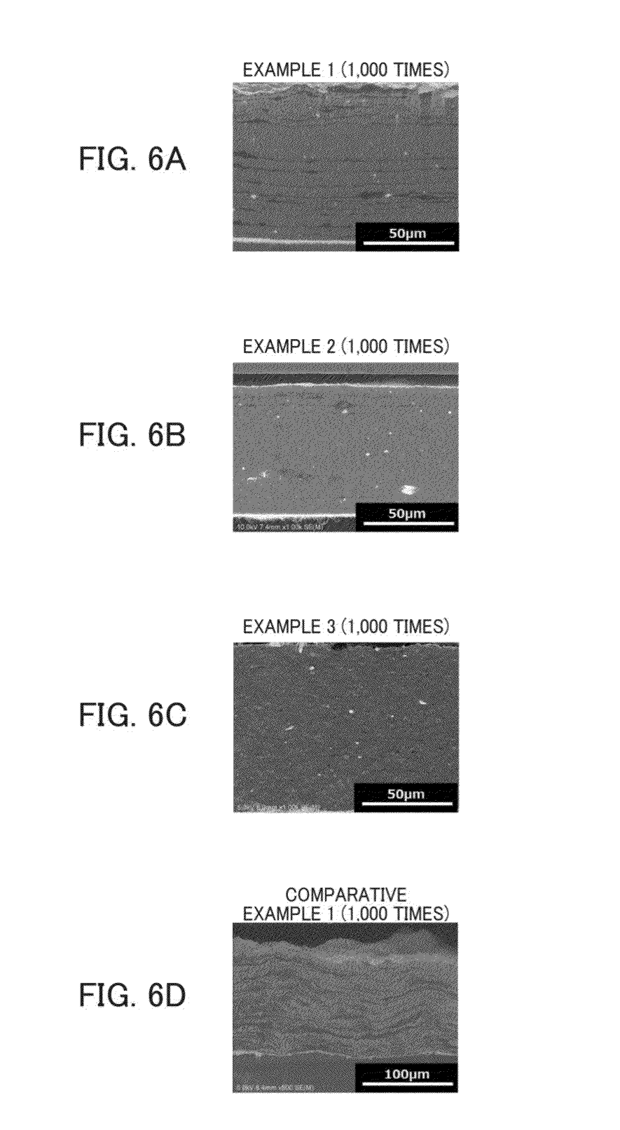

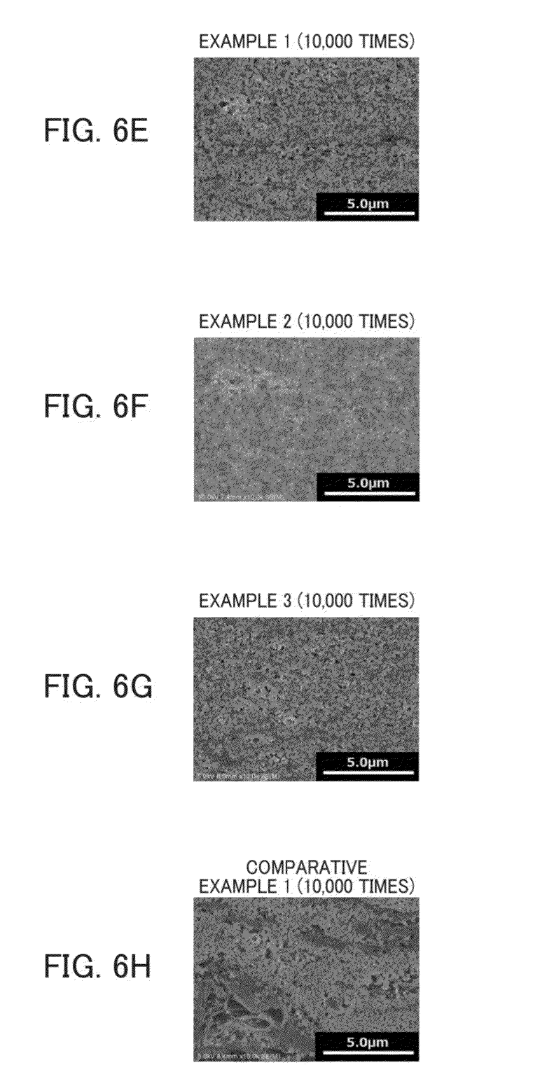

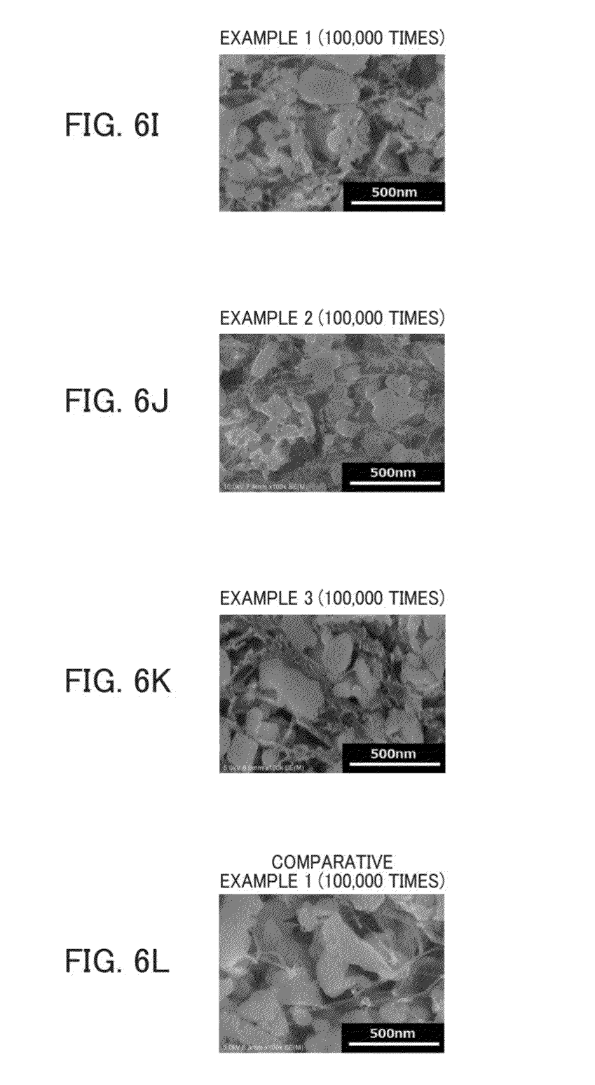

Each electrode obtained in Examples 1 to 3 and Comparative Example 1 was subjected to a cross-section observation with an SEM. FIGS. 6A to 6L illustrate SEM images of the cross-sections of the electrodes of Examples 1 to 3 and Comparative Example 1 obtained by the cross-section observation with the SEM. In more detail, FIGS. 6A to 6D illustrate SEM images (magnification of 1,000 times) of the cross-sections of the electrodes of Examples 1 to 3 and Comparative Example 1, FIGS. 6E to 6H illustrate SEM images (magnification of 10,000 times) of the cross-sections of the electrodes of Examples 1 to 3 and Comparative Example 1, and FIGS. 6I to 6L illustrate SEM images (magnification of 100,000 times) of the cross-sections of the electrodes of Examples 1 to 3 and Comparative Example 1.

As illustrated in FIGS. 6A to 6L, compared with the electrodes of Examples 1 to 3 containing the dispersant, aggregation due to insufficient dispersion treatment was found in the electrode of Comparative Example 1 not containing the dispersant. From this result, it was confirmed that the electrodes of Examples 1 to 3 containing the dispersant had uniform inner structures.

(Charging/Discharging Test of the Electrodes of Example 4 and Comparative Example 2)

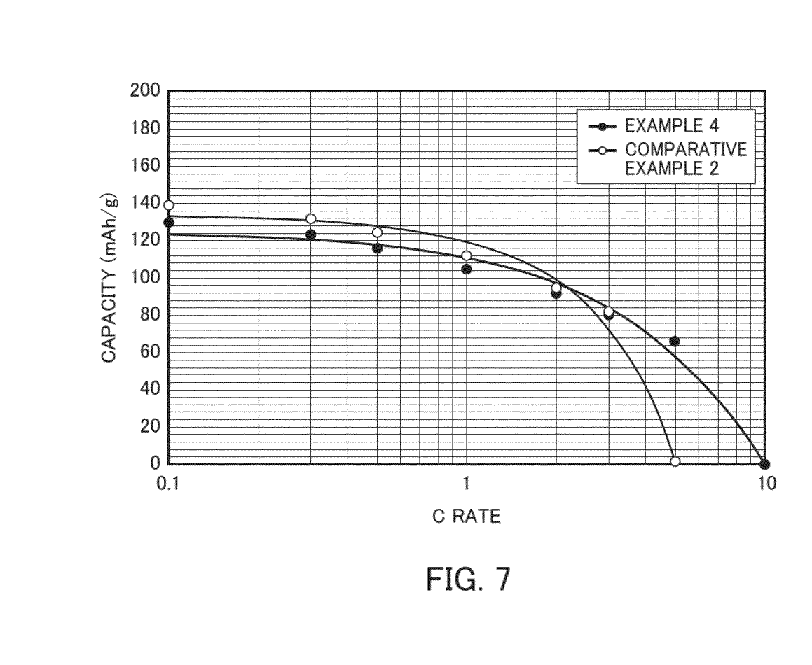

Each electrode obtained in Example 4 and Comparative Example 2 was subjected to a charging/discharging test after being incorporated in the lithium-ion battery. The charging/discharging test was performed under the same conditions as in the above-described charging/discharging test. FIG. 7 is a diagram illustrating the charging/discharging curves of the batteries of Example 4 and Comparative Example 2. The horizontal axis and the vertical axis are the same as in FIG. 4.

As illustrated in FIG. 7, it was found that Example 4, in which the electrode using the acetylene black and Ketjen black instead of the MWNT as the conductive additive and containing the LDS as the dispersant was used, had excellent output characteristics compared with the Comparative Example 2 in which the electrode using the acetylene black and Ketjen black instead of the MWNT as the conductive additive and not containing the dispersant was used. From this result, it was confirmed that excellent output characteristics could be obtained by using the electrode containing the dispersant regardless of the types of conductive additive.

(FT-IR Measurement of Electrodes of Example 4 and Comparative Example 2)

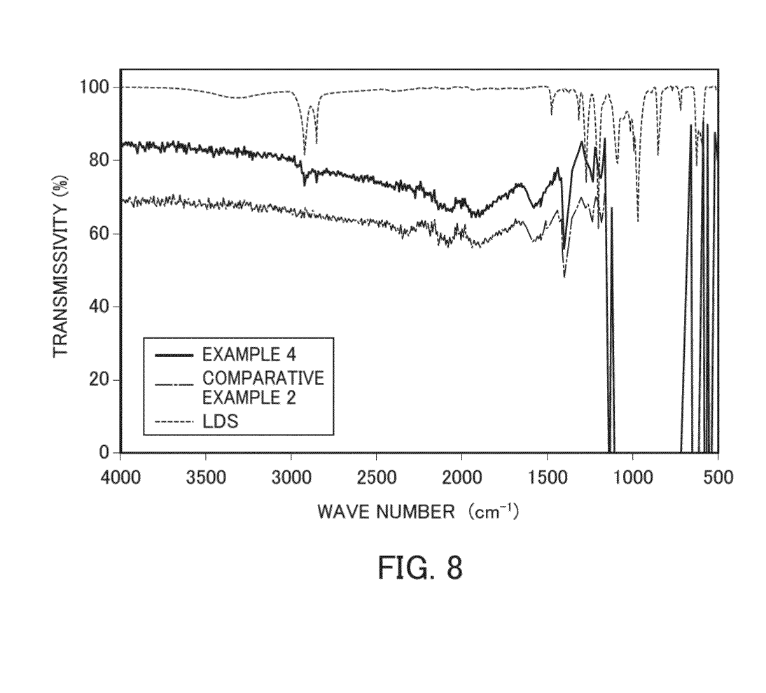

Each electrode obtained in Example 4 and Comparative Example 2 was subjected to an FT-IR measurement. FIG. 8 is a diagram illustrating the FT-IR spectra of the electrodes of Example 4 and Comparative Example 2. In FIG. 8, the vertical axis indicates IR transmissivity, and the horizontal axis indicates wave number. Furthermore, FIG. 8 also illustrates the standard spectrum of the LDS for reference.

As illustrated in FIG. 8, a peak was observed near the wave numbers 2800 to 3000 cm⁻¹ in the FT-IR spectrum of the electrode of Example 4 containing the LDS as the dispersant. This peak was not observed in the FT-IR spectrum of the electrode of Comparative Example 2, which has the same constitution as that of Example 4 except for not containing the dispersant and it was found that this peak was a peak derived from the LDS in comparison with the LDS standard spectrum. Accordingly, it was confirmed that the LDS of the dispersant was certainly contained in the electrode of Example 4.

(Cross-Section Observation with SEM of Electrodes of Examples 1 and 8 to 10)

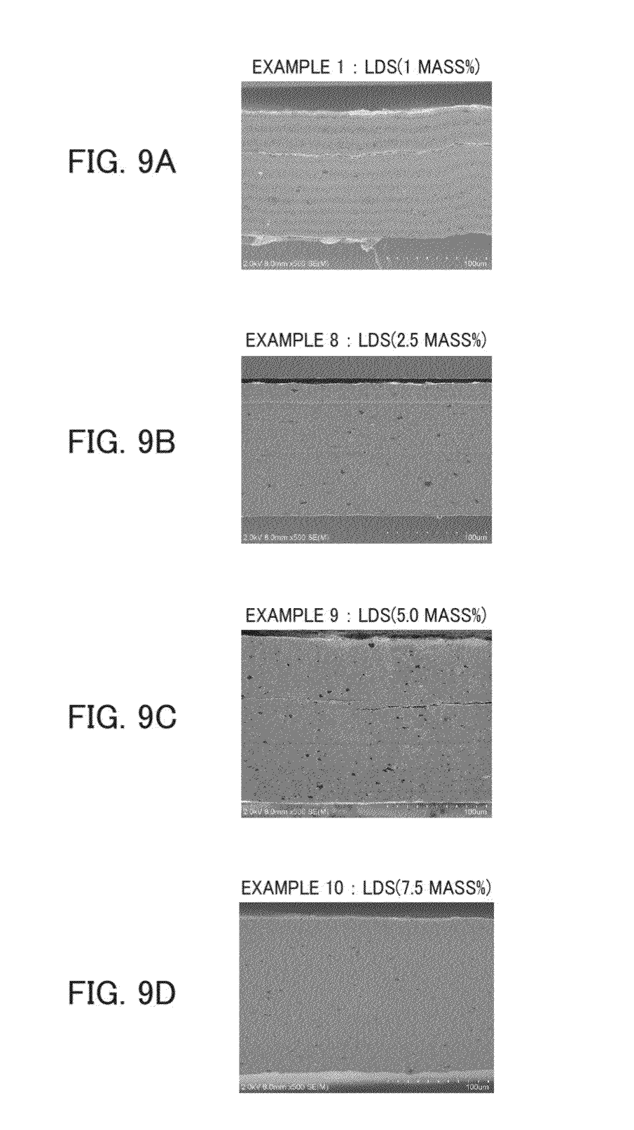

Each electrode obtained in Examples 1 and 8 to 10 was subjected to a cross-section observation with an SEM. FIGS. 9A to 9D illustrate SEM images of the cross-sections of the electrodes of Examples 1 and 8 to 10 obtained by the cross-section observation with the SEM. In more detail, FIGS. 9A to 9D illustrate SEM images (magnification of 500 times) of the cross-sections of the electrodes of Examples 1 and 8 to 10.

As illustrated in FIGS. 9A to 9D, it was found that the uniformity of the electrode structure was improved with the increase of the LDS content in the dispersant solution. From the fact that the uniformity of the electrode structure contributed to the improvement of the output and charging/discharging characteristics of the battery and the battery capacity, it was found that the output and charging/discharging characteristics of the battery and the battery capacity were improved with the increase of the LDS content in the dispersant solution.

Furthermore, it was found that generation performance of the battery could be improved by selecting a specific dispersant and intentionally leaving the dispersant, which would be removed in the manufacturing process of the electrode, in the electrode. In particular, when the LDS content in the dispersant solution is 2.5 mass % or more, it was found that the uniformity of the electrode structure was significantly improved.

(Charging/Discharging Test Electrodes of Examples 1 and 8 to 10 and Comparative Example 1)

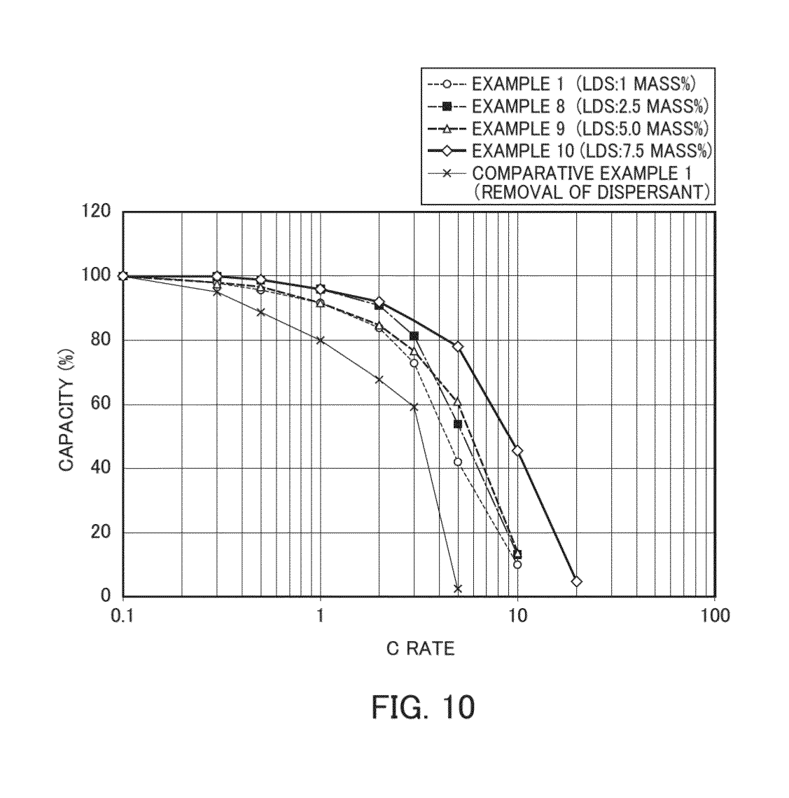

Each electrode obtained in Examples 1 and 8 to 10 and Comparative Example 1 was subjected to a charging/discharging test after being incorporated in the lithium-ion battery. The charging/discharging test was performed under the same conditions as in the above-described charging/discharging test. FIG. 10 is a diagram illustrating the charging/discharging curves of the batteries of Examples 1 and 8 to 10 and Comparative Example 1. The horizontal axis and the vertical axis are the same as in FIGS. 4 and 7.

As illustrated in FIG. 10, it was found that the output of the battery was improved with the increase of the LDS content in the dispersant solution. From the fact that sufficient output of the battery could not obtained in the electrode of Comparative Example 1 to which the LDS was not added, it was found that the LDS content in the dispersant solution was preferably 0.01 mass % or more. In addition, from the fact that the battery performance was improved with the increase of the LDS content in the dispersant solution, it was found that the upper limit of the LDS content in the dispersant solution was an amount equivalent to the saturation concentration at the treatment temperature.

What is claimed is:

1. An electrode comprising an active material and a conductive additive,
wherein the electrode also includes a dispersant, and
the dispersant is adsorbed onto surfaces of the conductive additive and the active material.

2. The electrode according to claim 1, wherein the dispersant includes a dispersant having at least one kind selected from a group consisting of molecular structures, atoms, and ions which acts as a charge transfer medium.

3. The electrode according to claim 2, wherein the charge transfer medium has the same charge as the charge transfer medium contained in the active material.

4. The electrode according to claim 3, wherein the charge transfer medium is the same as the charge transfer medium contained in the active material.

5. The electrode according to claim 4, wherein the dispersant is an anionic surfactant.

6. The electrode according to claim 5, wherein the dispersant is at least one kind selected from a group consisting of metal dodecyl sulfate, metal dodecyl benzene sulfonate, and metal stearate.

7. The electrode according to claim 6, wherein the dispersant is at least one kind selected from a group consisting of lithium dodecyl sulfate, sodium dodecyl sulfate, lithium dodecyl benzene sulfonate, sodium dodecyl benzene sulfonate, lithium stearate, and sodium stearate.

8. The electrode according to claim 1, wherein the conductive additive is at least one kind selected from a group consisting of carbon nanotubes, carbon black, acetylene black, and Ketjen black.

9. The electrode according to claim 8, wherein the carbon nanotubes include carbon nanotubes having metallic properties.

10. A secondary battery being provided with the electrode according to claim 1.

11. The secondary battery according to claim 10, wherein the secondary battery is a lithium-ion secondary battery.

12. The secondary battery according to claim 10, wherein the secondary battery is a sodium-ion secondary battery.

13. An air battery being provided with the electrode according to claim 1.

14. The air battery according to claim 13, wherein the air battery is a lithium/air battery.

15. The air battery according to claim 13, wherein the air battery is a sodium/air battery.

16. An electric double-layered capacitor being provided with the electrode according to claim 1.

17. The electric double-layered capacitor according to claim 16, wherein the electric double-layered capacitor is a lithium-ion capacitor.

18. The electric double-layered capacitor according to claim 16, wherein the electric double-layered capacitor is a sodium-ion capacitor.

19. A manufacturing method of an electrode, comprising:
a first process of preparing a dispersion liquid containing an active material, a conductive additive, a solvent, and a dispersant using a dispersant having at least one kind selected from a group consisting of molecular structures, atoms, and ions which acts as a charge transfer medium; and
a second process of manufacturing an electrode by removing only the solvent from the dispersion liquid.
